(19) United States
(12) Patent Application Publication
(10) Pub. No.: US 2018/0249724 A1
(43) Pub. Date: Sep. 6, 2018

(54) Modified atmosphere and high-pressure pasteurization protein preparation packaging methods, systems and related devices

(71) Applicant: Iowa Pacific Processors, Inc., Des Moines, IA (US)

(72) Inventor: Michael Everett, Kaneohe, HI (US)

(21) Appl. No.: 15/932,235

(22) Filed: Feb. 16, 2018

Related U.S. Application Data
(60) Provisional application No. 62/459,888, filed on Feb. 16, 2017.

(51) Int. Cl. A23B 4/16; B65B 25/00; A23L 3/015; A23L 3/3445

(52) U.S. Cl. CPC A23B 4/16; B65B 25/001; A23V 2002/00; A23L 3/3445; A23L 3/015

(57) ABSTRACT

The disclosed apparatus, systems and methods relate to modified atmosphere and pasteurized retail fresh protein preparations. Protein is packaged in a modified atmosphere lacking significant amounts of oxygen and then exposed to high-pressure pasteurization. The protein can be sealed or bagged within the modified atmosphere, and that combined with high-pressure pasteurization can extend the shelf-life of the packaged protein.

### CROSS-REFERENCE TO RELATED APPLICATION(S)

This application claims priority to U. S. Provisional Application No. 62/459,888 filed Feb. 16, 2017 and entitled “Protein Preparation Systems, Devices and Related Methods,” which is hereby incorporated by reference in its entirety under 35 U.S.C. § 119(e).

### TECHNICAL FIELD

The disclosure relates to devices, systems and methods for the preparation and storage of proteins in a retail environment. Namely, the disclosure relates to a packaging system, devices and methods that allow for a significant reduction in pathogens, extended shelf-life of protein, such as fresh beef, lamb, pork, poultry, fish, fowl and bison.

### BACKGROUND

Prior art retail protein presentation methods and devices often present a number of shortcomings. These can include pathogens, limited shelf life for fresh meat, such as beef, lamb, pork, poultry, fish, fowl, bison and the like, as well as other meat alternative forms of protein known in the art (hereinafter generally referred to as “protein”), less skilled labor in the protein department, increasing overhead, lacks traceability, regimented add campaigns which are not in tune to market opportunities providing greater gross margins.

Under prior art approaches, protein suppliers generally fabricate carcasses into so-called “subprimals” which are typically cryovac or vacuum packaged. In this subprimal state the protein typically has a shelf life of approximately the following: beef/lamb for 40 days, pork for 15 days and chicken for 7 days. his material is also contaminated with various pathogens which can be harmful to the consumer if not cooked properly.

There is a need in the art for improved methods of protein preparation.

### BRIEF SUMMARY

Described herein are various embodiments relating to devices, systems and methods for protein processing, packaging and preparation. Although multiple embodiments, including various devices, systems, and methods are described herein as a “system,” this is in no way intended to be restrictive.

In one Example, a system for retail protein preparation, including: a modified atmosphere device configured to seal the protein in a modified atmosphere; and a high-pressure pasteurization device configured to pasteurize the sealed protein. Implementations may include one or more of the following features. The system where the modified atmosphere includes carbon monoxide. The system where the modified atmosphere includes carbon dioxide. The system where the modified atmosphere includes nitrogen. The system where the modified atmosphere includes carbon dioxide carbon monoxide and nitrogen. The system where the modified atmosphere does not include oxygen. Other embodiments include corresponding computer systems, apparatus, and computer programs recorded on one or more computer storage devices, each configured to perform the actions of the methods. Implementations of the described techniques may include hardware, a method or process, or computer software on a computer-accessible medium.

One Example includes a method for fresh retail protein preparation, including operating a packaging system including a modified atmosphere device configured to expose the protein to a modified atmosphere and seal the protein in a container. The method of this Example also includes a high-pressure pasteurization device constructed and arranged to pasteurize the sealed protein within the sealed container, where the system is configured to perform steps including a modified atmosphere step, and a high-pressure pasteurization step, where the protein is sealed in a modified atmosphere and exposed to HPP.

Implementations according to this and other Examples may include one or more of the following features. The method where the modified atmosphere includes carbon monoxide. The method where the modified atmosphere includes carbon dioxide. The method where the modified atmosphere includes nitric oxide. The method where the modified atmosphere includes carbon dioxide, carbon monoxide and nitrogen. The method where the modified atmosphere does not include oxygen.

Another Example includes a method for high-pressure pasteurization of protein, including at least one modified atmosphere step where the protein is sealed in a modified atmosphere, and at least high-pressure pasteurization step performed on the sealed modified atmosphere protein.

Yet a further Example includes a method of packaging protein in a modified atmosphere for high-pressure pasteurization, including several steps a preparation step, including a physical preparation sub-step and a chemical preparation sub-step, a modified atmosphere step including a modified atmosphere introduction sub-step and a sealing sub-step, and a high-pressure pasteurization step including an HPP sub-step, where the protein is sealed and high-pressure pasteurized in a container with a modified atmosphere including carbon monoxide, carbon dioxide, and nitrogen without substantial oxygen.

Implementations of these Examples may include one or more of the following features. The method where the modified atmosphere step includes a modified atmosphere sub-step, and a sealing sub-step. The method where the modified atmosphere includes carbon monoxide, carbon dioxide, and nitrogen. The method where the modified atmosphere includes carbon monoxide, carbon dioxide, and nitrogen. The method where the modified atmosphere includes about 0.4% carbon monoxide. The method where the modified atmosphere includes about 20% carbon dioxide. The method where the modified atmosphere includes more than 79% nitrogen. The method where the high-pressure pasteurization step includes a coding/dating sub-step and a scanning sub-step. The method where the high-pressure pasteurization step includes an HPP sub-step. The method where the HPP sub-step is performed on the sealed modified atmosphere protein at about 87,000 psi. The method where the HPP sub-step is performed on the sealed modified atmosphere protein for about 3 minutes. The method where the HPP sub-step is performed on the sealed modified atmosphere protein for between about 1 second and about 3600 seconds. The method where the HPP sub-step is performed on the sealed modified atmnsphere protein at between about 13,500 and about 87,000 psi.

In various implementations featuring automation, a system of one or more components including computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is an illustrative flow diagram of an exemplary embodiment of the protein packaging process, according to exemplary implementations.

FIG. 2 is a top-view floorplan of a facility capable of performing the protein packaging process, according to one implementation.

FIG. 3 is a perspective view of a several components utilized in the process, including a weighing device.

FIG. 4 is a perspective view of a modified atmosphere device comprising a conduit and bagging chute, according to one implementation.

FIG. 5 is an end-long view of the modified atmosphere device of FIG. 4.

FIG. 6 is a perspective view of a bagged and sealed protein in a modified atmosphere on a conveyor belt, according to one implementation.

FIG. 7 is a perspective view of a conveyor and HPP device, according to one implementation.

FIG. 8 is a further perspective view of an HPP device, according to one implementation.

FIG. 9 is yet a further side view of an HPP device, according to one implementation.

### DETAILED DESCRIPTION

The various embodiments disclosed or contemplated herein are directed to systems, methods and devices for packaging of protein in an air-tight bag or other container, wherein the bag, wherein the protein is exposed to a modified atmosphere within the bag and the bag is exposed to high-pressure pasteurization . In various implementations, a variety of automated or semi-automated components can be used to execute a variety of steps and sub-steps to prepare such packaged protein. These implementations represent a significant departure from the known techniques and components utilized in the art, and can improve shelf-life and other features of the packaged protein, as will be described in detail herein.

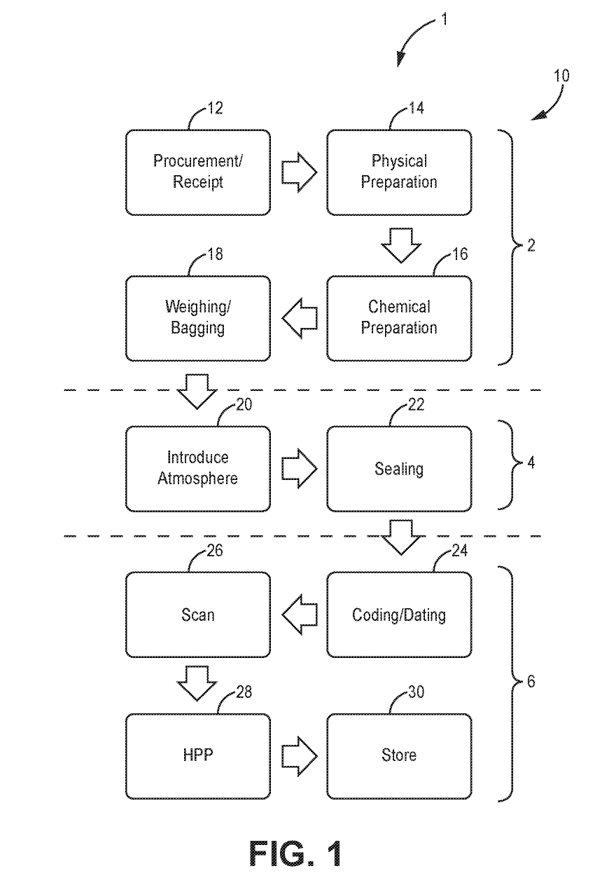

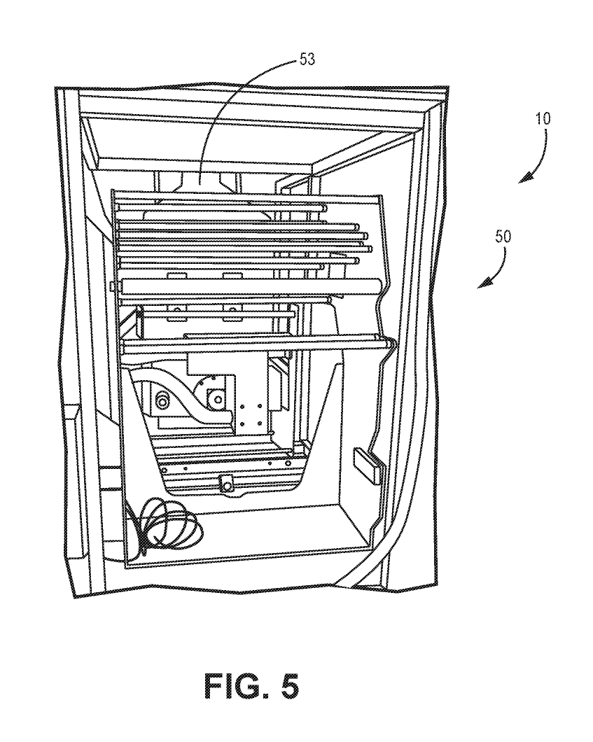

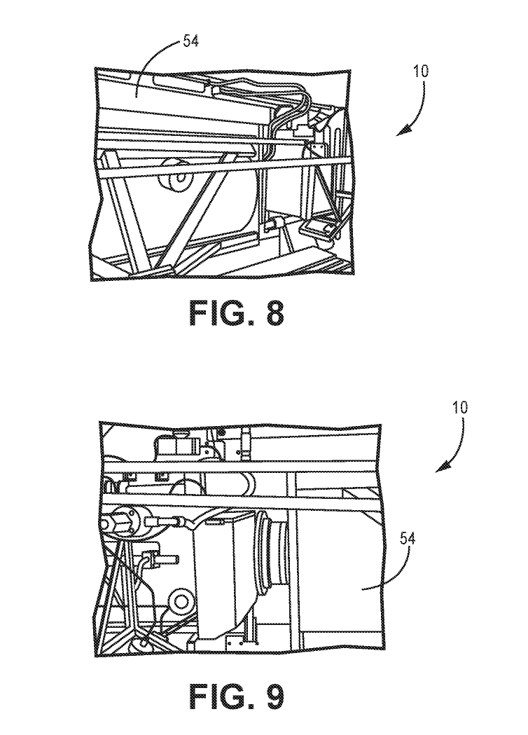

FIGS. 1-9 depict several exemplary implementation of the protein packaging process 1 executed via the operation of a packaging system 10 comprising several components, some of which are automated or semi-automated. The various implementations relate to packaging a protein such as meat is sealed in an air-tight container containing a modified atmosphere and exposed to high-pressure pasteurization(meaning isostatic pressures of up to about 600 MPa/87,000 psi or more) for improved shelf-life and other advantages, as is described in detail herein.

Through the combination of the modified atmosphere with the use of HPP, the implementations allow for a significant reduction in pathogens and extended shelf-life of the packaged protein. In these implementations, the final packaged protein can be traced back to the source, thereby adding another important food safety element in the supply network. It is understood that these edible proteins are considered a commodity market at one stage or another in the process or path to the end user.

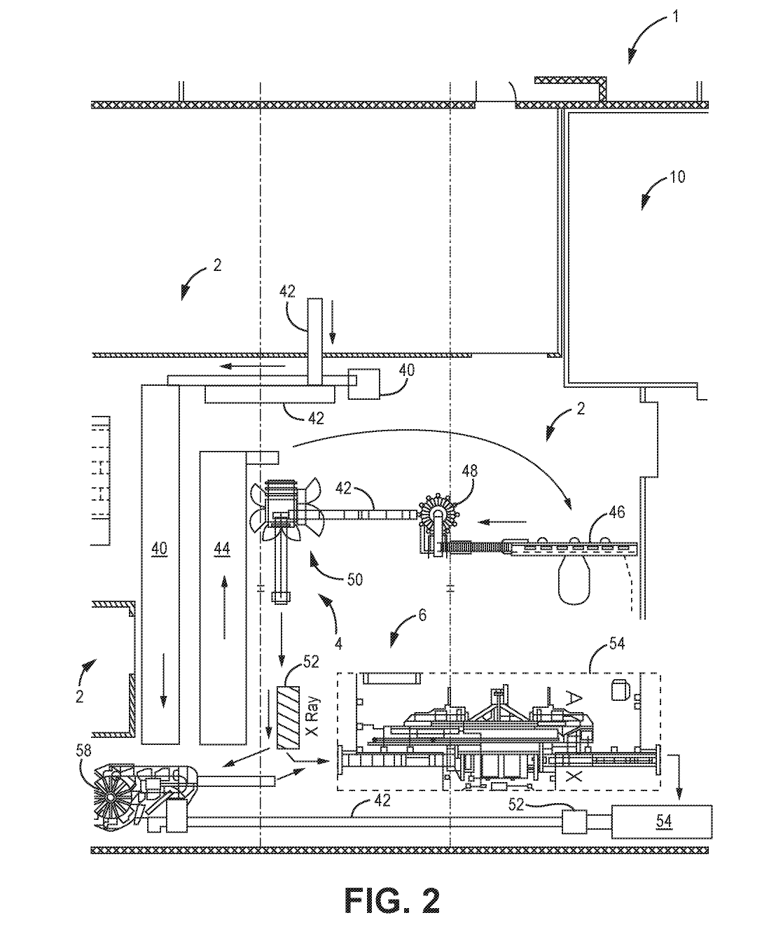

Turning to the drawings in greater detail, in the implementation of FIG. 1, in performing the process or method 1, comprises various optional steps and sub-steps. It is understood that in various implementations, a packaging system 10 is constructed and arranged to perform this process 1 by utilizing several components, various implementations of this system 10 are depicted in FIGS. 2-9.

The disclosed implementations involve several optional steps which may be performed in any order, and that additional steps may be included, while others may be omitted, depending on the specific implementation. The example packaging system 10 of FIG. 1 is provided to illustrate the optional steps, but is in no way intended to limit the embodiments to this particular implementation.

In these implementations, and as shown in FIG. 1, the steps in exemplary implementations of the process include:

1. an optional preparation and sealing step 2,

2. an modified atmosphere step 4; and

3. a high-pressure pasteurization step 6

Other steps can be included, and in various aspects each of these steps 2, 4, 6 can comprise various sub-steps, as is shown in the implementation of FIG. 1.

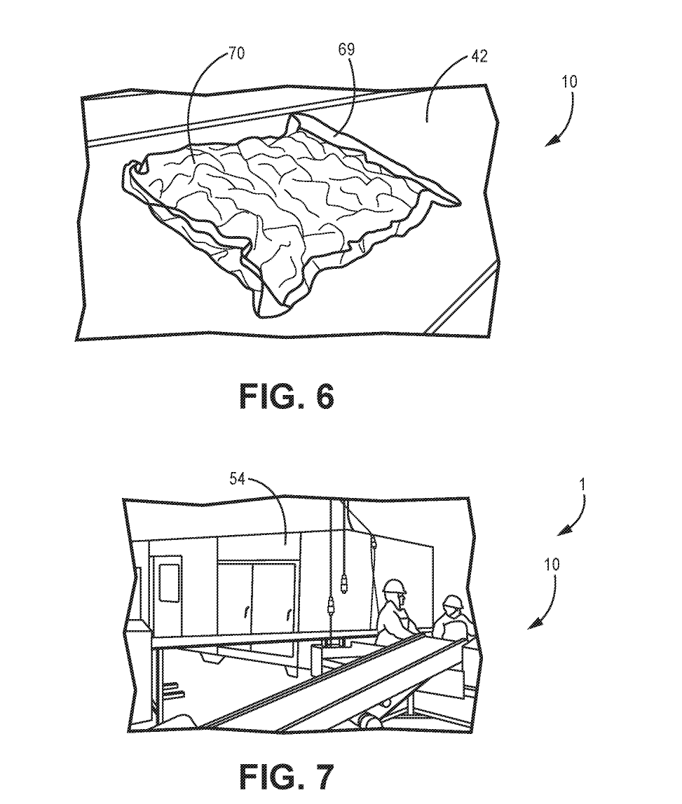

In the optional preparation and sealing step 2 according to various implementations like that of FIG. 1, a protein (shown in FIG. 6 at 70) can be procured, received, treated and packaged in an atmosphere-resistant bag or other container, as described herein. In alternate implementations, the protein can be pre-bagged or otherwise contained in an air-tight container for processing in the atmospheric 4 and pasteurization 6 steps.

As shown in FIG. 1, in one exemplary implementation of the disclosed method 1 is implemented on a packaging system 10 during the optional preparation and sealing step 2, in the protein (shown in FIG. 6 at 70) enters the system 10, for example, through an optional procurement/receipt sub-step (box 12). In this sub-step (box 12) according to certain implementations, a procurement order is issued, such as from a central processing component or computer (not shown),In these implementations, the order can trigger delivery and receipt of the protein—such as meat—for cataloging via supply-chain and inventory systems known and understood in the art.

In various implementations, the protein for processing can be one or more of fresh beef, lamb, pork, poultry, fish, fowl, bison and the like. In various implementations, more than one protein—such as a blend of chicken and beef—may be used for implementations preparing fajitas, stir fry or other preparations that are understood and appreciated in the art.

Continuing with the preparation and sealing steps 2 of the implementation of FIG. 1 and as further shown in FIG. 2, the entering protein can be vacuum packed or fresh, but in any case an optional physical preparation sub-step (box 14) can be performed. During such a physical preparation sub-step (box 14), it is understood that various preparatory techniques can be employed at the preparation and sealing step 2 to prepare the protein for processing the subsequent steps and/or sub-steps of the system 10. These sub-steps generally aim for conversion from subprimal or subprime material to retail presentation through understood techniques such as boning, trimming and portioning. For example, subprimal beef chuck eye roll is cut into roast and trimmings.

As would be further appreciated, in certain implementations during the preparation and sealing step 2 according to certain aspects, a chemical preparation sub-step (box 16) is performed. During the chemical preparation sub-step (box 16) in these aspects, marinades or other treatment and/or seasoning techniques may be applied to the protein prior to optional weighing and bagging in a weighing/bagging sub-step (box 18),It is understood that in these implementations, during the chemical preparation sub-step (box 16) various flavored or neutral marinades may be introduced and/or utilized to prepare the product to a desired flavor and/or color.

In these implementations, the weighing/bagging sub-step (box 18) completes the preparation step 2. While it is apparent that weighing is generally optional, the product must be bagged or otherwise inserted into an air-tight container in during this sub-step (box 18) to ready it for the modified atmosphere step 4.

In one illustrative example, the system can be constructed and arranged such that the pre-bagged protein is about 16 oz. In other examples, it is about 6 oz, 8 oz, 10 oz, 12 oz or more. In further examples, it is a weight between 1 oz and 64 oz. In additional implementations, the protein is more than 64 oz. In yet further examples, the protein comprises a variety of individual pieces that in sum weigh about a specified amount, such as shrimp or fajita cuts. It is understood that a variety of sizes and weights are possible, depending on the final retail application.

In certain implementations, the barrier film or barrier bag (shown in FIG. 6 at 69) used in the weighing/bagging sub-step (box 18) can be a nylon, 3-ply bag, though other high barrier implementations are possible, including metallic, Saran®, PET, and others known and understood by those of skill in the art to have the proper gas permeability to retain the introduced modified atmosphere.

As is shown in FIG. 2, the preparation 2 sub-steps can be performed, for example by way of an arrangement of tables 40 conveyors 42, graders 44 tumblers 46 and/or weighing devices 48. It is understood myriad configurations are possible, as would be understood by the skilled artisan.

In these implementations, following the preparation step 2, an modified atmosphere step 4 is performed. The modified atmosphere step 4 generally relates to the introduction of a modified atmosphere (“MA”) to the protein. In various implementations, the modified atmosphere is a combination of carbon monoxide, carbon dioxide, and nitrogen. As will be apparent to one of skill in the art, many additional atmospheric compositions are possible.

In one illustrative example, the prepared, portioned and weighed protein, such as at the end of the weighing/bagging step (box 18) is exposed to a modified atmosphere via a modified atmosphere introduction sub-step (box 20) and then packaged or sealed in a sealing sub-step (box 22), as shown in FIG. 1.

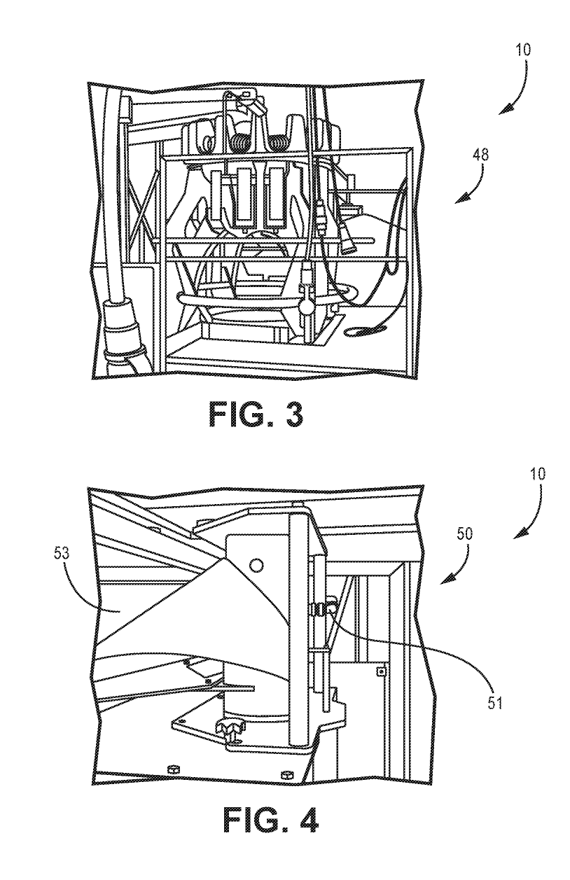

As shown in FIG. 2, the modified atmosphere introduction sub-step and the sealing sub-step can be performed in rapid succession via an automatic bagger or MA device 50 for further processing. It is understood that the introduction of the modified atmosphere to the protein and sealing of the package or bag can be performed in a variety of alternative ways. In certain implementations, and as shown in FIGS. 3-5, the MA device 50 is configured to package the product in a barrier film within a bagging chute 53 that is filled with a modified atmosphere via a conduit 51. Other filling and bagging methods and systems can be utilized in alternate implementations.

In certain implementations the oxygen is flushed from the protein, and the modified atmosphere includes about 0.4% carbon monoxide, about 20% carbon dioxide, and the remainder (more than 79% or about 80%) is nitrogen. It is understood that in these and other implementations, it is desirable to exclude oxygen from the modified atmosphere.

In further implementations, the carbon monoxide concentration can be about 0.1% or less, and can increase to 0.2%, 0.3% or more, or can exceed 0.5%, 1.0% or up to 100% of the atmosphere.

Similarly, the modified atmosphere can include less than 20% carbon dioxide, down to 0.1% or less. In alternate implementations, the modified atmosphere can include more than 20% carbon dioxide, such as 25%, 30%, 40%, 50% or more, up to 100%. In all of these implementations, nitrogen can comprise the remainder of the atmosphere.

In certain implementations, ranges from about 0% to about 100% nitric oxide and/or carbon dioxide can also be introduced into the mixture. Alternatively, other inert gases may be introduced into the atmosphere. However, in exemplary implementations, the modified atmosphere of most implementations does not contain oxygen, as would be readily understood by one of skill in the art.

Continuing with the implementations of FIGS. 1-2, and FIGS. 6-9, the protein sealed in a modified atmosphere (“MA protein”—shown in FIG. 6 at 70) can be taken through a high-pressure pasteurization step 6 comprising one or more post-sealing sub-steps via conveyors 42 and other devices used in the industry and understood in the art.

In certain implementations, during the high-pressure pasteurization step 6, the MA protein 70 a sub-step of performing HPP is required, but several other optional sub-steps relating to processing can also be performed.

For example, after the protein has been sealed (as shown in FIG. 1 for example in box 22), it can optionally be bag dated or coded in a coding/dating sub-step (box 24) and/or scanned or X-rayed in a scanning sub-step (box 26 and in FIG. 2 at 52) to ensure quality and/or compliance, such as with USDA regulations. It is understood that various white-labeling and other marketing badges may also be applied to the bag at or between any of these optional pasteurization 6 sub-steps. Alternate implementations do not include these sub-steps, while yet further alternate implementations comprise additional packaging, labeling and quality-control sub-steps understood in the art.

Crucially, as shown in FIGS. 7-9, the MA protein—now sealed in a modified atmosphere environment as shown in FIG. 6 at 70—is exposed to high-pressure pasteurization (“HPP”) in a HPP sub-step, as is shown in FIG. 1 at box 28 and in FIGS. 7-9 at the HPP 54. The use of HPP is critical for the functioning of the system and methods 10 during the high-pressure pasteurization step 6.

In one implementation, the HPP sub-step (box 28) is performed at up to about 87,000 psi for a duration of about 3 minutes or more. Various alternative implementations can utilize HPP of 300-600 MPa/43,500-87,000 psi or more, over durations of from about less than about a minute to more than about ten minutes, more than about 20 minutes, more than about 30 minutes, more than about 60 minutes or longer, depending on the environment, conditions, and the like. Various implementations can perform the HPP sub-step from about 1 second to about 3600 seconds or more at between about 43,500 and about 87,000 psi or more.

In certain implementations, the pressure for all processing is kept below about 50 degrees, though alternate implementations may vary from freezing to room-temperature or higher. It will be appreciated by the skilled artisan that the HPP sub-step does not cause the rupture of the bag in these implementations because the pressure is being applied to the bag or other air-tight or sufficiently gaseous-impermeable container uniformly.

In various implementations, the pasteurized packages are subsequently dried off, packed off in a case and palletized in a storage sub-step, as is shown in FIG. 1 at box 30 and in FIG. 2 at 56.

In certain implementations, the system 10 can further comprise a water bath, as, such as a 180 degree water bath, or any other bath from about 33 degrees or more. In these implementations, the system is able to pull a vacuum (shown in FIG. 2 at 58) on the sealed bag 69. These implementations result in a freezable product that can be provided to commercial outlets, but may turn the protein an undesirable color.

However, as would be understood by one of kill in the art, sealed protein 70 can either be exposed to MA or be vacuum packed. Accordingly, in certain implementations of the system, an alternate route or series of steps can be performed such that processing for vacuum packing and MA processing can both be performed in the same facility at substantially the same time.

In various implementations, the finished product bags will be about 1 lb. each, and can be packaged in 40 lb. boxes on 1800 lb. pallets, so as to present an economically viable shipping method. Other configurations are of course possible, as would be appreciated by one of skill in the art.

At this point the product can and will remain edible in the fresh state at follows: beef/lamb=60 days, pork 45 days and chicken 30 days. The product still needs to be refrigerated at 28 to 36 degrees Fahrenheit, which again already exists in the marketplace today.

In various implementations, the disclosed devices, systems and methods also provide an extended protein shelf life for the retailer, and a safer product for the consumer. Given the differences in advertising cycles and shelf life in the current retail environment, retailers typically purchase advertising at least a month prior to the actual purchase of proteins. Typically, these ads are driven on the basis of seasonal trends, and tend to “lock” the retailer into a sales promotion for the designated period. The presently-disclosed systems, devices and methods allow the retailer to defer or minimize this marketing decision, thus allowing the retailer to select less-expensive cuts of product when suppliers have excess, thereby keeping costs down and creating efficiency. As described below, protein from these market buys can be held for, for example, 30 or 50 days, then processed using the presently disclosed methods, systems and devices, thereby providing an additional shelf life of up to about 60 days. These improvements will be appreciated by those of skill in the art.

It is understood that the improved product presentation of the protein according to various implementations will provide numerous benefits to the end retailer, who will have a clean, extended shelf-life product that does not require trimming, boning, packaging and the like. These retailers will therefore enjoy less overhead, while reducing the need for skilled labor. The traceable, and possibly private labeled, product will go directly in the fresh protein counter. These packaged protein units also benefit the consumer, who in turn will be purchasing a high quality portion of protein, which is safe, looks normal, and can be trace all the way back to its source facility. The retailer will not have any rework, or shrinkage (other than possibly pilferage), thus reducing the overall number of preparation steps for all the proteins carried by the retailer. Further, as discussed above, the retailer can take advantage of avoiding the peak time of the year for buying, while still being able to sell into the seasonal trends.

Although the disclosure has been described with reference to preferred embodiments, persons skilled in the art will recognize that changes may be made in form and detail without departing from the spirit and scope of the disclosed apparatus, systems and methods.

What is claimed is:

1. A method for fresh retail protein preparation, comprising:
a. operating a packaging system comprising:
i. a modified atmosphere device configured to expose the protein to a modified atmosphere and seal the protein in a container; and
ii. a high-pressure pasteurization device constructed and arranged to pasteurize the sealed protein within the sealed container,
wherein the system is configured to perform steps comprising:
i. a modified atmosphere step; and
ii. a high-pressure pasteurization step,
wherein the protein is sealed in a modified atmosphere and exposed to HPP.

2. The method of claim 1, wherein the modified atmosphere comprises carbon monoxide.

3. The method of claim 1, wherein the modified atmosphere comprises carbon dioxide.

4. The method of claim 1, wherein the modified atmosphere comprises nitric oxide.

5. The method of claim 1, wherein the modified atmosphere comprises carbon dioxide, carbon monoxide and nitrogen.

6. The method of claim 5, wherein the modified atmosphere does not comprise oxygen.

7. A method for high-pressure pasteurization of protein, comprising:
a. at least one modified atmosphere step wherein the protein is sealed in a modified atmosphere; and
b. at least high-pressure pasteurization step performed on the sealed modified atmosphere protein.

8. The method of claim 7, wherein the modified atmosphere step comprises:
a. a modified atmosphere sub-step; and
b. a sealing sub-step.

9. The method of claim 7, wherein the modified atmosphere consists of carbon monoxide, carbon dioxide, and nitrogen.

10. The method of claim 7, wherein the modified atmosphere comprises carbon monoxide, carbon dioxide, and nitrogen.

11. The method of claim 10, wherein the modified atmosphere comprises about 0.4% carbon monoxide.

12. The method of claim 11, wherein the modified atmosphere comprises about 20% carbon dioxide.

13. The method of claim 12, wherein the modified atmosphere comprises more than 79% nitrogen.

14. The method of claim 7, wherein the high-pressure pasteurization step comprises a coding/dating sub-step and a scanning sub-step.

15. The method of claim 7, wherein the high-pressure pasteurization step comprises an HPP sub-step.

16. The method of claim 15, wherein the HPP sub-step is performed on the sealed modified atmosphere protein at about 87,000 psi.

17. The method of claim 15, wherein the HPP sub-step is performed on the sealed modified atmosphere protein for about 3 minutes.

18. The method of claim 15, wherein the HPP sub-step is performed on the sealed modified atmosphere protein for between about 1 second and about 3600 seconds.

19. The method of claim 18, wherein the HPP sub-step is performed on the sealed modified atmosphere protein at between about 43,500 and about 87,000 psi.

20. A method of packaging protein in a modified atmosphere for high-pressure pasteurization, comprising several steps:
a. a preparation step, comprising a physical preparation sub-step and a chemical preparation sub-step;
b. a modified atmosphere step comprising a modified atmosphere introduction sub-step and a sealing sub-step; and
c. a high-pressure pasteurization step comprising a HPP sub-step,
wherein the protein is sealed and high-pressure pasteurized in a container with a modified atmosphere comprising carbon monoxide, carbon dioxide, and nitrogen without substantial oxygen.
